(19) United States
(12) Patent Application Publication
(10) Pub. No.: US 2020/0300181 A1
(43) Pub. Date: Sep. 24, 2020

(54) GAS TURBINE AND CONTROL METHOD THEREFOR

(71) Applicant: MITSUBISHI HEAVY INDUSTRIES, LTD., Tokyo (JP)

(72) Inventors: Kenji MIYAMOTO, Tokyo (JP); Kotaro MIYAUCHI, Kanagawa (JP); Kei INOUE, Kanagawa (JP); Tomo KAWAKAMI, Kanagawa (JP)

(21) Appl. No.: 16/088,632

(22) PCT Filed: Mar. 24, 2017
(86) PCT No.: PCT/JP2017/011967

§ 371 Date: Sep. 26, 2018

(30) Foreign Application Priority Data
Mar. 29, 2016 (JP) 2016-065393

(51) Int. Cl. F02C 9/40; F02C 7/22; F23R 3/28; F23R 3/36; F23R 3/34

(52) U.S. Cl. CPC F02C 9/40; F02C 7/22; F23R 3/343; F23R 3/36; F23R 3/28

(57) ABSTRACT

A gas turbine provided with: a first nozzle including a first-nozzle radially inner fuel injection hole from which to inject a first-nozzle fuel and a first-nozzle radially outer fuel injection hole which is formed on a radially outer side of the first nozzle relative to the first-nozzle radially inner fuel injection hole and upstream of the first-nozzle radially inner fuel injection hole with respect to the flow of air inside a combustor and from which to inject the first-nozzle fuel, and in a case where the first-nozzle fuel is made of a moderate calorie fuel, the first-nozzle fuel is constantly injected from the first-nozzle radially inner fuel injection hole while the gas turbine is driven, and the first-nozzle fuel is constantly injected from the first-nozzle radially outer fuel injection hole while the gas turbine is driven at a rated rotation speed.

### TECHNICAL FIELD

The present invention relates to a gas turbine and a control method therefor.

### BACKGROUND ART

The combustor in a gas turbine is provided with a first nozzle and a second nozzle. A flame obtained by combusting a fuel injected from the first nozzle (first-nozzle fuel) is used as a pilot for combustion of a fuel from the second nozzle (second-nozzle fuel).

As described in Patent Document 1 listed below, in the case of using a gas turbine for power generation, the gas turbine is required to withstand a load rejection test. Load rejection refers to emergency disconnection of the generator and the gas turbine due to a certain cause, upon which the gas turbine needs to be shifted immediately to a rated-rotation-speed no-load state.

Meanwhile, some plants are required to be operated using the same combustor with a high calorie fuel (a fuel mainly containing a hydrocarbon such as methane and containing only a small amount of inert gases such as nitrogen and carbon dioxide) and a moderate calorie fuel (a fuel mainly containing a hydrocarbon such as methane and containing a large amount of inert gases such as nitrogen and carbon dioxide). In order for such a plant to succeed in load rejection during use of the moderate calorie fuel, it is necessary to supply the fuel at a high flow rate from the first nozzle. Accordingly, the hole diameter of the first nozzle needs to be increased.

### PRIOR ART DOCUMENT

### Patent Document

Patent Document 1: Japanese Patent No. 3472424

### SUMMARY OF THE INVENTION

### Problem to be Solved by the Invention

However, the nozzle differential pressure drops when the high calorie fuel is used with the first nozzle with its hole diameter increased in consideration of load rejection during use of the moderate calorie fuel. This leads to a possibility of back flow of a high-temperature gas into the first nozzle.

Thus, in view of the above technical problem, an object of the present invention is to provide a gas turbine and a control method therefor that, in the case of using the same combustor with a high calorie fuel and a moderate calorie fuel, can prevent the occurrence of back flow of a high-temperature gas into a first nozzle during use of the high calorie fuel and can also ensure a necessary supply of the first-nozzle fuel when load rejection occurs during use of the moderate calorie fuel.

### Means for Solving the Problem

A gas turbine according to a first aspect of the invention to solve the above problem is a gas turbine being capable of load rejection and including a combustor for use with a high calorie fuel and a moderate calorie fuel, the combustor including a first nozzle that injects a first-nozzle fuel into a flow of air inside the combustor, and a second nozzle that injects a second-nozzle fuel into the flow of air inside the combustor, the first-nozzle fuel being made of the high calorie fuel or the moderate calorie fuel, the second-nozzle fuel being made of the high calorie fuel or the moderate calorie fuel and combusted using, as a pilot, a flame obtained by combusting the fuel injected from the first nozzle, the gas turbine characterized in that the first nozzle includes a first-nozzle radially inner fuel injection hole from which to inject the first-nozzle fuel and a first-nozzle radially outer fuel injection hole which is formed on a radially outer side of the first nozzle relative to the first-nozzle radially inner fuel injection hole and upstream of the first-nozzle radially inner fuel injection hole with respect to the flow of air inside the combustor and from which to inject the first-nozzle fuel, and in a case where the first-nozzle fuel is made of the moderate calorie fuel, the first-nozzle fuel is constantly injected from the first-nozzle radially inner fuel injection hole while the gas turbine is driven, and the first-nozzle fuel is constantly injected from the first-nozzle radially outer fuel injection hole while the gas turbine is driven at a rated rotation speed.

A gas turbine according to a second aspect of the invention to solve the above problem is the gas turbine according to the first aspect of the invention, the gas turbine further includes:

a first-nozzle radially inner fuel supply pipe which is one pipe branched from a first-nozzle fuel system that supplies the first-nozzle fuel, and which communicates at a downstream end thereof with the first-nozzle radially inner fuel injection hole;

a first-nozzle radially outer fuel supply pipe which is another pipe branched from the first-nozzle fuel system and communicates at a downstream end thereof with the first-nozzle radially outer fuel injection hole;

a pressure adjustment valve which is provided upstream of a branch point in the first-nozzle fuel system and to which a pressure-adjustment-valve controller that controls a valve opening degree thereof is connected;

a first flow rate adjustment valve which is provided to the first-nozzle radially inner fuel supply pipe and to which a first-flow-rate-adjustment-valve controller that controls a valve opening degree thereof is connected; and a second flow rate adjustment valve which is provided to the first-nozzle radially outer fuel supply pipe and to which a second-flow-rate-adjustment-valve controller that controls a valve opening degree thereof is connected, and in the case where the first-nozzle fuel is made of the moderate calorie fuel, the pressure-adjustment-valve controller, the first-flow-rate-adjustment-valve controller, and the second-flow-rate-adjustment-valve controller control the valve opening degrees of the pressure adjustment valve, the first flow rate adjustment valve, and the second flow rate adjustment valve, respectively, so as to constantly inject the first-nozzle fuel from the first-nozzle radially inner fuel injection hole while the gas turbine is driven, and constantly inject the first-nozzle fuel further from the first-nozzle radially outer fuel injection hole while the gas turbine is driven at a rated rotation speed.

A gas turbine according to a third aspect of the invention to solve the above problem is the gas turbine according to the first or second aspect of the invention, in which hole diameters of the first-nozzle radially inner fuel injection hole and the first-nozzle radially outer fuel injection hole are hole diameters suitable for a case where the first-nozzle fuel is made of the high calorie fuel.

A method of controlling a gas turbine according to a fourth aspect of the invention to solve the above problem is a method of controlling a gas turbine being capable of load rejection and including a combustor for use with a high calorie fuel and a moderate calorie fuel, the combustor including a first nozzle that injects a first-nozzle fuel into a flow of air inside the combustor, and a second nozzle that injects a second-nozzle fuel into the flow of air inside the combustor, the first-nozzle fuel being made of the high calorie fuel or the moderate calorie fuel, the second-nozzle fuel being made of the high calorie fuel or the moderate calorie fuel and combusted using, as a pilot, a flame obtained by combusting the fuel injected from the first nozzle,

the method characterized in that the method includes:

providing the first nozzle with a first-nozzle radially inner fuel injection hole which is formed in a downstream tip portion of a body of the first nozzle and from which to inject the first-nozzle fuel and a first-nozzle radially outer fuel injection hole which is formed on a radially outer side of the first nozzle relative to the first-nozzle radially inner fuel injection hole and upstream of the first-nozzle radially inner fuel injection hole with respect to the flow of air inside the combustor and from which to inject the first-nozzle fuel; and

in a case where the first-nozzle fuel is made of the moderate calorie fuel, constantly injecting the first-nozzle fuel from the first-nozzle radially inner fuel injection hole while the gas turbine is driven, and constantly injecting the first-nozzle fuel from the first-nozzle radially outer fuel injection hole while the gas turbine is driven at a rated rotation speed.

A method of controlling a gas turbine according to a fifth aspect of the invention to solve the above problem is the method of controlling a gas turbine according to the fourth aspect of the invention, the method further includes:

providing the gas turbine with
a first-nozzle radially inner fuel supply pipe which is one pipe branched from a first-nozzle fuel system that supplies the first-nozzle fuel, and which communicates at a downstream end thereof with the first-nozzle radially inner fuel injection hole,
a first-nozzle radially outer fuel supply pipe which is another pipe branched from the first-nozzle fuel system and communicates at a downstream end thereof with the first-nozzle radially outer fuel injection hole,
a pressure adjustment valve which is provided upstream of a branch point in the first-nozzle fuel system and to which a pressure-adjustment-valve controller that controls a valve opening degree thereof is connected,
a first flow rate adjustment valve which is provided to the first-nozzle radially inner fuel supply pipe and to which a first-flow-rate-adjustment-valve controller that controls a valve opening degree thereof is connected, and
a second flow rate adjustment valve which is provided to the first-nozzle radially outer fuel supply pipe and to which a second-flow-rate-adjustment-valve controller that controls a valve opening degree thereof is connected; and

in the case where the first-nozzle fuel is made of the moderate calorie fuel, controlling the valve opening degrees of the pressure adjustment valve, the first flow rate adjustment valve, and the second flow rate adjustment valve so as to constantly inject the first-nozzle fuel from the first-nozzle radially inner fuel injection hole while the gas turbine is driven, and constantly inject the first-nozzle fuel further from the first-nozzle radially outer fuel injection hole while the gas turbine is driven at a rated rotation speed.

A method of controlling a gas turbine according to a sixth aspect of the invention to solve the above problem is the method of controlling a gas turbine according to the fourth or fifth aspect of the invention, in which hole diameters of the first-nozzle radially inner fuel injection hole and the first-nozzle radially outer fuel injection hole are hole diameters suitable for a case where the first-nozzle fuel is made of the high calorie fuel.

### Effect of the Invention

With the gas turbine and the control method therefor according to the present invention, it is possible to, in the case of using the same combustor with a high calorie fuel and a moderate calorie fuel, prevent the occurrence of back flow of a high-temperature gas into a first nozzle during use of the high calorie fuel and also ensure a necessary supply of the first-nozzle fuel when load rejection occurs during use of the moderate calorie fuel.

### BRIEF DESCRIPTION OF THE DRAWINGS

FIG. 1 is a schematic diagram of a combustor provided in a gas turbine according to an embodiment of the present invention.

FIG. 2 is a system diagram of a first-nozzle fuel system according to the embodiment of the present invention.

FIG. 3 is a graph of a fuel schedule illustrating the relation between load and fuel supply amounts during moderate calorie fuel use in the embodiment of the present invention.

FIG. 4 is a graph illustrating the fuel supply amounts after load rejection during the moderate calorie fuel use in the embodiment of the present invention.

### MODE FOR CARRYING OUT THE INVENTION

A gas turbine and a control method therefor according to the present invention will be described through an embodiment with reference to the drawings.

### Embodiment

First, the configuration of a gas turbine according to this embodiment will be described. A gas turbine provided in a gas turbine plant uses a fuel gas (gaseous fuel) as its fuel. The gas turbine includes a compressor, a combustor, and a turbine, which are not illustrated, and obtains electric power by rotating a generator with the output of the turbine. Also, the gas turbine according to this embodiment is capable of load rejection.

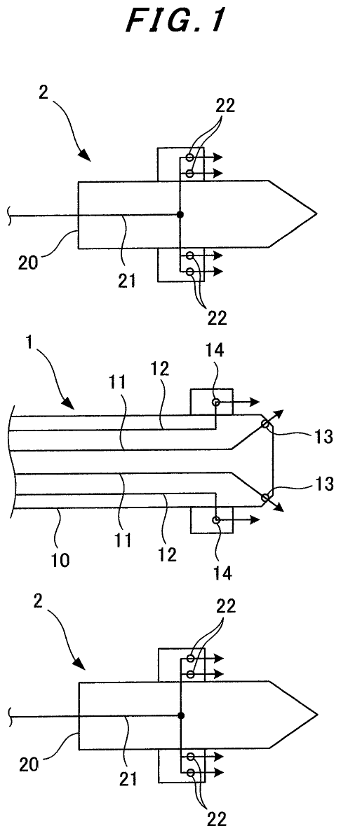

FIG. 1 is a schematic diagram of the combustor provided in the gas turbine according to the embodiment of the present invention. As illustrated in FIG. 1, the combustor provided in the gas turbine according to this embodiment is for use with a high calorie fuel and a moderate calorie fuel and includes a first nozzle 1 and a plurality of second nozzles 2 disposed around the outer periphery of the first nozzle 1.

The first nozzle 1 injects a first-nozzle fuel, which is a fuel gas (premixed fuel or diffusion fuel), into a flow of air inside the combustor. Note that this first-nozzle fuel is made of the high calorie fuel or the moderate calorie fuel.

Also, the first nozzle 1 includes: a first-nozzle body 10 disposed along the direction of airflow inside the combustor; a plurality of first-nozzle radially inner fuel supply pipes 11 extending inside the first-nozzle body 10; a plurality of first-nozzle radially outer fuel supply pipes 12 extending, likewise, inside the first-nozzle body 10; a plurality of first-nozzle radially inner fuel injection holes 13 formed at the downstream end of the first-nozzle body 10; and a plurality of first-nozzle radially outer fuel injection holes 14 formed on a downstream side of the first-nozzle body 10.

The plurality of first-nozzle radially inner fuel injection holes 13 communicate respectively with the downstream ends of the plurality of first-nozzle radially inner fuel supply pipes 11, and the plurality of first-nozzle radially outer fuel injection holes communicate respectively with the downstream ends of the plurality of first-nozzle radially outer fuel supply pipes 12. Further, the plurality of first-nozzle radially outer fuel injection holes 14 are formed respectively on a radially outer side of the first nozzle 1 relative to the plurality of first-nozzle radially inner fuel injection holes 13 and upstream of the plurality of first-nozzle radially inner fuel injection holes 13 with respect to the flow of airflow inside the combustor.

Also, in this embodiment, the hole diameters of the first-nozzle radially inner fuel injection holes 13 and the first-nozzle radially outer fuel injection holes 14 are small sizes suitable for use of the high calorie fuel (a case where the first-nozzle fuel is made of the high calorie fuel).

On the other hand, the second nozzles 2 inject a second-nozzle fuel, which is a fuel gas (premixed fuel), into the flow of air inside the combustor. Note that this second-nozzle fuel is made of the high calorie fuel or the moderate calorie fuel, as in the first-nozzle fuel.

Also, as with conventional configurations, each second nozzle 2 includes: a second-nozzle body 20 disposed along the direction of airflow inside the combustor; a second-nozzle fuel supply pipe 21 extending inside the second-nozzle body 20; and a plurality of second-nozzle fuel injection holes 22 formed on the downstream side of the second-nozzle body 20.

The downstream side of the second-nozzle fuel supply pipe 21 is branched into a plurality of pipes, and the plurality of second-nozzle fuel injection holes 22 communicate respectively with the downstream ends of the branched second-nozzle fuel supply pipes 21.

The plurality of second-nozzle fuel injection holes 22 are each provided upstream of the plurality of first-nozzle radially inner fuel injection holes 13 and the plurality of first-nozzle radially outer fuel injection holes 14, which are provided in the first nozzle 1, with respect to the flow of air inside the combustor.

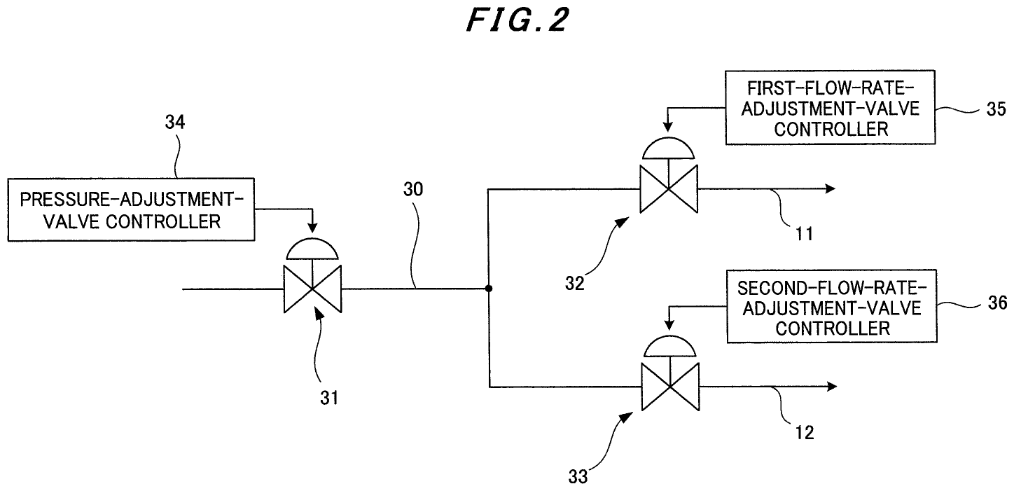

FIG. 2 is a system diagram illustrating a first-nozzle fuel system. As illustrated in FIG. 2, a first-nozzle fuel system 30 that supplies the first-nozzle fuel to the first nozzle 1 is branched into two systems which are the above-described first-nozzle radially inner fuel supply pipes 11 and first-nozzle radially outer fuel supply pipes 12.

A pressure adjustment valve 31 is provided upstream of the branch point in the first-nozzle fuel system 30 at which it is branched into the above two systems. The first-nozzle radially inner fuel supply pipes 11 are provided with a first flow rate adjustment valve 32, and the first-nozzle radially outer fuel supply pipes 12 are provided with a second flow rate adjustment valve 33.

Also, a pressure-adjustment-valve controller 34 that controls the valve opening degree of the pressure adjustment valve is connected to the pressure adjustment valve 31, a first-flow-rate-adjustment-valve controller 35 that controls the valve opening degree of the first flow rate adjustment valve 32 is connected to the first flow rate adjustment valve 32, and a second-flow-rate-adjustment-valve controller 36 that controls the valve opening degree of the second flow rate adjustment valve 33 is connected to the second flow rate adjustment valve 33.

The pressure-adjustment-valve controller 34, the first-flow-rate-adjustment-valve controller 35, and the second-flow-rate-adjustment-valve controller 36 control the valve opening degrees of the pressure adjustment valve 31, the first flow rate adjustment valve 32, and the second flow rate adjustment valve 33, respectively, in accordance with the load state of the gas turbine.

Note that each second-nozzle fuel system is also provided with an adjustment valve and a controller that controls the control valve, but their illustration and description are omitted here.

The above is the configuration of the gas turbine according to this embodiment. The operation (and effects) of the gas turbine according to this embodiment with the above configuration will now be described.

In the first nozzle 1, the first-nozzle fuel supplied through the first-nozzle radially inner fuel supply pipes 11 (first-nozzle radially inner fuel) is injected into the combustor from the first-nozzle radially inner fuel injection holes 13, communicating with the downstream ends of the first-nozzle radially inner fuel supply pipes 11. Also, the first-nozzle fuel supplied through the first-nozzle radially outer fuel supply pipes 12 (first-nozzle radially outer fuel) is injected into the combustor from the first-nozzle radially outer fuel injection holes 14, communicating with the downstream ends of the first-nozzle radially outer fuel supply pipes 12. Flames obtained by combusting these fuels injected from the first nozzle 1 are used as pilots for combustion by the second nozzles 2.

In each second nozzle 2, the second-nozzle fuel supplied through the second-nozzle fuel supply pipe 21 is injected into the combustor from the second-nozzle fuel injection holes 22, communicating with the downstream ends of the second-nozzle fuel supply pipe 21. The second-nozzle fuel injected into the flow of air inside the combustor from the second-nozzle fuel supply pipe 21 is combusted using the flames produced by the first nozzle 1 as pilots.

Also, in this embodiment, as already described, the hole diameters of the first-nozzle radially inner fuel injection holes 13 and the first-nozzle radially outer fuel injection holes 14 are small sizes suitable for use of the high calorie fuel (the case where the first-nozzle fuel is made of the high calorie fuel). In this way, it is possible to maintain a nozzle differential pressure during use of the high calorie fuel.

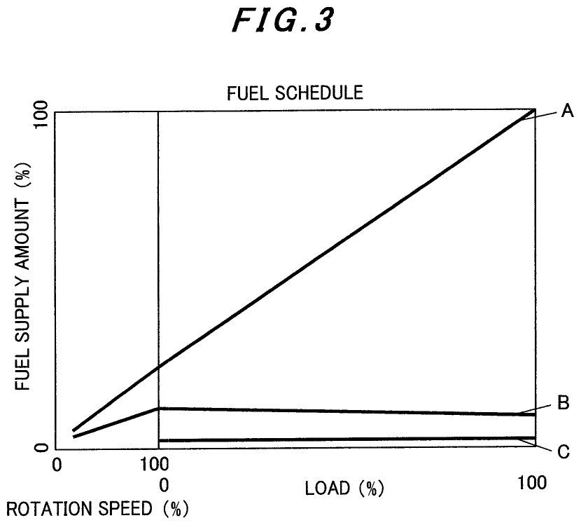

Here, FIG. 3 is a graph of a fuel schedule illustrating the relation between load and fuel supply amounts during moderate calorie fuel use (a case where the first-nozzle fuel and the second-nozzle fuel are made of the moderate calorie fuel) in this embodiment. The horizontal axis indicates the rotation speed (%) of the turbine and the load (%) thereon, and the vertical axis indicates the fuel supply amounts (%). Note that, the fuel supply amounts (%) are proportions based on the assumption that the fuel supply amount of the second-nozzle fuel when the rated rotation speed and the load are 100% is 100%. In the graph of FIG. 3, reference sign A denotes the second-nozzle fuel, reference sign B denotes the first-nozzle radially inner fuel, and reference sign C denotes the first-nozzle radially outer fuel.

As with conventional configurations, for the second-nozzle fuel supply pipe 21 in each second nozzle 2, the valve opening degree of the adjustment valve (not illustrated) provided to the second-nozzle fuel supply pipe 21 is controlled by its controller (not illustrated) so as to start the supply of the second-nozzle fuel when the gas turbine starts to be driven, and increase the supply amount of the second-nozzle fuel with rise in the rotation speed of the gas turbine and the load thereon such that the supply amount can be 100% when the load is 100% (A in FIG. 3).

For the first-nozzle radially inner fuel supply pipes 11 in the first nozzle 1, the valve opening degrees of the pressure adjustment valve 31 and the first flow rate adjustment valve 32 are controlled by the pressure-adjustment-valve controller 34 and the first-flow-rate-adjustment-valve controller 35 so as to start the supply of the first-nozzle radially inner fuel when the gas turbine starts to be driven, and constantly supply the first-nozzle radially inner fuel while the gas turbine is driven (that is, constantly inject the first-nozzle radially inner fuel from the first-nozzle radially inner fuel injection holes 13 while the gas turbine is driven). Specifically, the valve opening degrees are controlled so as to gradually increase the supply amount of the first-nozzle radially inner fuel until the rotation speed of the gas turbine rises to 100%, and then gradually decrease the supply amount as the load on the gas turbine rises from 0 to 100% (B in FIG. 3).

Also, for the first-nozzle radially outer fuel supply pipes 12 in the first nozzle 1, the valve opening degrees of the pressure adjustment valve 31 and the second flow rate adjustment valve 33 are controlled by the pressure-adjustment-valve controller 34 and the second-flow-rate-adjustment-valve controller 36 such that, in a state where the rotation speed of the gas turbine is 100% (while the gas turbine is driven at the rated rotation speed), the first-nozzle radially outer fuel supply pipes 12 constantly supply the first-nozzle radially outer fuel in a small amount regardless of the load (during normal operation) (that is, the first-nozzle radially outer fuel is constantly injected from the first-nozzle radially outer fuel injection holes 14 in addition to the first-nozzle radially inner fuel while the gas turbine is driven at the rated rotation speed) (C in FIG. 3). Note that the small amount here is to 0.01 to 1%.

In sum, in this embodiment, in the case where the first-nozzle fuel is made of the moderate calorie fuel, the first-nozzle radially inner fuel is constantly injected from the first-nozzle radially inner fuel injection holes 13 while the gas turbine is driven, and the first-nozzle radially outer fuel is constantly injected from the first-nozzle radially outer fuel injection holes 14 while the gas turbine is driven at the rated rotation speed (while the load is 0% to 100%). This setting is used for the following reasons.

Firstly, a gas turbine generally needs to abruptly decrease the supply amount of the second-nozzle fuel and, at the same time, increase the supply amount of the first-nozzle fuel when a load rejection (rated-rotation-speed no-load) instruction is given.

However, with the hole diameters of the first-nozzle radially inner fuel injection holes 13 and the first-nozzle radially outer fuel injection holes 14 being small to be suitable for high calorie use as in this embodiment, then, if only supply of the first-nozzle radially inner fuel from the first-nozzle radially inner fuel supply pipes 11 is taken into account and supply of the first-nozzle radially outer fuel from the first-nozzle radially outer fuel supply pipes 12 is not taken into account, the supply amount of the first-nozzle radially inner fuel cannot be instantly increased to the necessary amount when a load rejection instruction is given during use of the moderate calorie fuel.

Also, even if supply of the first-nozzle radially outer fuel from the first-nozzle radially outer fuel supply pipes 12 is taken into account, the supply rate cannot follow the sudden change by load rejection in a case where the first-nozzle radially outer fuel is not supplied from the first-nozzle radially outer fuel supply pipes 12 during the normal operation. Hence, it is still impossible to increase the supply amount of the first-nozzle fuel (first-nozzle radially inner fuel+first-nozzle radially outer fuel) instantly to the necessary amount when load rejection occurs during use of the moderate calorie fuel.

However, in this embodiment, in order to prevent the fuel supply amount from being small when a load rejection instruction is given during use of the moderate calorie fuel, the first-nozzle radially outer fuel is constantly supplied in a small amount (by controlling the valve opening degrees of the pressure adjustment valve 31 and the second flow rate adjustment valve 33 with the pressure-adjustment-valve controller 34 and the second-flow-rate-adjustment-valve controller 36). In this way, the necessary amount of first-nozzle fuel (first-nozzle radially inner fuel+first-nozzle radially outer fuel) can be supplied immediately when a load rejection instruction is given.

In sum, in this embodiment, a fuel constantly is supplied in a small amount from the first-nozzle radially outer fuel supply pipes 12, so that the fuel is constantly filled in the supply piles. In this way, when a load rejection instruction is given during use of the moderate calorie fuel, it is possible to instantly increase the fuel supply amount of the first-nozzle radially outer fuel (into the combustor) and therefore cover the shortage of the supply amount of the first-nozzle radially inner fuel in the necessary amount.

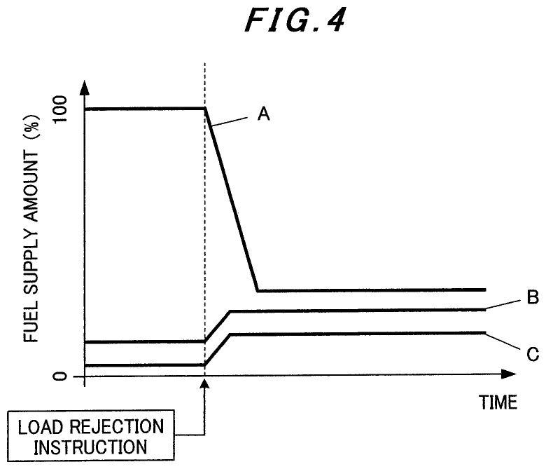

FIG. 4 is a graph illustrating the fuel supply amounts after load rejection occurs during moderate calorie fuel use in this embodiment. The horizontal axis indicates time, and the vertical axis indicates the fuel supply amounts (%). In the graph of FIG. 4, reference sign A denotes the second-nozzle fuel, reference sign B denotes the first-nozzle radially inner fuel, and reference sign C denotes the first-nozzle radially outer fuel.

After the load rejection (rated-rotation no-load) instruction is given, the second-nozzle fuel has the value in the graph of FIG. 3 at the point at which the rotation speed is 100% and the load is 0%, as with conventional techniques. Specifically, the valve opening degree of the adjustment value (not illustrated) provided to the second-nozzle fuel supply pipe 21 is controlled by its controller (not illustrated) so as to abruptly decrease the second-nozzle fuel supplied from the second-nozzle fuel supply pipe 21 (A in FIG. 4).

Simultaneously, the valve opening degrees of the pressure adjustment valve 31, the first flow rate adjustment valve 32, and the second flow rate adjustment valve 33 are controlled by the pressure-adjustment-valve controller 34, the first-flow-rate-adjustment-valve controller 35, and the second-flow-rate-adjustment-valve controller 36, respectively, so as to increase the first-nozzle radially inner fuel and the first-nozzle radially outer fuel supplied from the first-nozzle radially inner fuel supply pipes 11 and the first-nozzle radially outer fuel supply pipes 12 (B and C in FIG. 4). Here, as described above, the first-nozzle radially outer fuel has been filed in the supply pipes. It is therefore possible to ensure an increase to the necessary amount.

The above is the description of the operation (and effects) of the gas turbine according to this embodiment.

Note that although the first-nozzle radially outer fuel is small in amount in the above description, this embodiment is not limited to this. For example, the supply amount of the first-nozzle radially outer fuel may be about equal to that of the first-nozzle radially inner fuel. However, when the first-nozzle radially outer fuel is small in amount, it is possible to suppress generation of NOx. In addition, when the first-nozzle radially outer fuel in this embodiment is a premixed fuel, it is possible to suppress generation of NOx.

Also, a method of controlling a gas turbine according to this embodiment is a method of controlling a gas turbine being capable of load rejection and comprising a combustor for use with a high calorie fuel and a moderate calorie fuel, this combustor including a first nozzle 1 that injects a first-nozzle fuel into a flow of air inside the combustor, and a second nozzle 2 that injects a second-nozzle fuel into the flow of air inside the combustor, the first-nozzle fuel being made of the high calorie fuel or the moderate calorie fuel, the second-nozzle fuel being made of the high calorie fuel or the moderate calorie fuel and combusted using, as a pilot, a flame obtained by combusting the fuel injected from the first nozzle 1. The method includes: providing the first nozzle 1 with a first-nozzle radially inner fuel injection hole 13 which is formed in a downstream tip portion of a body of the first nozzle 1 and from which to inject the first-nozzle fuel and a first-nozzle radially outer fuel injection hole 14 which is formed on a radially outer side of the first nozzle 1 relative to the first-nozzle radially inner fuel injection hole 13 and upstream of the first-nozzle radially inner fuel injection hole 13 with respect to the flow of air inside the combustor and from which to inject the first-nozzle fuel; and in a case where the first-nozzle fuel is made of the moderate calorie fuel, constantly injecting the first-nozzle fuel from the first-nozzle radially inner fuel injection hole 13 while the gas turbine is driven, and constantly injecting the first-nozzle fuel from the first-nozzle radially outer fuel injection hole 14 while the gas turbine is driven at a rated rotation speed.

The method of controlling a gas turbine according to this embodiment further includes: providing the gas turbine with a first-nozzle radially inner fuel supply pipe 11 which is one pipe branched from a first-nozzle fuel system 30 that supplies the first-nozzle fuel, and which communicates at a downstream end thereof with the first-nozzle radially inner fuel injection hole 13, a first-nozzle radially outer fuel supply pipe 12 which is another pipe branched from the first-nozzle fuel system 30 and communicates at a downstream end thereof with the first-nozzle radially outer fuel injection hole 14, a pressure adjustment valve 31 which is provided upstream of a branch point in the first-nozzle fuel system 30 and to which a pressure-adjustment-valve controller 34 that controls a valve opening degree thereof is connected, a first flow rate adjustment valve 32 which is provided to the first-nozzle radially inner fuel supply pipe 11 and to which a first-flow-rate-adjustment-valve controller 35 that controls a valve opening degree thereof is connected, and a second flow rate adjustment valve 33 which is provided to the first-nozzle radially outer fuel supply pipe 12 and to which a second-flow-rate-adjustment-valve controller 36 that controls a valve opening degree thereof is connected; and in the case where the first-nozzle fuel is made of the moderate calorie fuel, controlling the valve opening degrees of the pressure adjustment valve 31, the first flow rate adjustment valve 32, and the second flow rate adjustment valve 33 so as to constantly inject the first-nozzle fuel from the first-nozzle radially inner fuel injection hole 13 while the gas turbine is driven, and constantly inject the first-nozzle fuel further from the first-nozzle radially outer fuel injection hole 14 while the gas turbine is driven at a rated rotation speed.

Further, in the method of controlling a gas turbine according to this embodiment, hole diameters of the first-nozzle radially inner fuel injection hole 13 and the first-nozzle radially outer fuel injection hole 14 are hole diameters suitable for a case where the first-nozzle fuel is made of the high calorie fuel.

The gas turbine and the control method therefor according to this embodiment has been described above. With the gas turbine and the control method therefor according to this embodiment, it is possible to certainly hold flames when load rejection occurs during use of a moderate calorie fuel, without increasing the hole diameter for the moderate calorie fuel use.

### INDUSTRIAL APPLICABILITY

The present invention is preferably applicable to a gas turbine and a control method therefor.

### REFERENCE SIGNS LIST

1 first nozzle
2 second nozzle
10 first-nozzle body
11 first-nozzle radially inner fuel supply pipe
12 first-nozzle radially outer fuel supply pipe
13 first-nozzle radially inner fuel injection hole
14 first-nozzle radially outer fuel injection hole
20 second-nozzle body
21 second-nozzle fuel supply pipe
22 second-nozzle fuel injection hole
30 first-nozzle fuel system
31 pressure adjustment valve
32 first flow rate adjustment valve
33 second flow rate adjustment valve
34 pressure-adjustment-valve controller
35 first-flow-rate-adjustment-valve controller
36 second-flow-rate-adjustment-valve controller

1. A gas turbine being capable of load rejection and comprising a combustor for use with a high calorie fuel and a moderate calorie fuel,
the combustor including a first nozzle that injects a first-nozzle fuel into a flow of air inside the combustor, and a second nozzle that injects a second-nozzle fuel into the flow of air inside the combustor, the first-nozzle fuel being made of the high calorie fuel or the moderate calorie fuel, the second-nozzle fuel being made of the high calorie fuel or the moderate calorie fuel and combusted using, as a pilot, a flame obtained by combusting the fuel injected from the first nozzle,
the gas turbine characterized in that
the first nozzle includes a first-nozzle radially inner fuel injection hole from which to inject the first-nozzle fuel and a first-nozzle radially outer fuel injection hole which is formed on a radially outer side of the first nozzle relative to the first-nozzle radially inner fuel injection hole and upstream of the first-nozzle radially inner fuel injection hole with respect to the flow of air inside the combustor and from which to inject the first-nozzle fuel, and
in a case where the first-nozzle fuel is made of the moderate calorie fuel, the first-nozzle fuel is constantly injected from the first-nozzle radially inner fuel injection hole while the gas turbine is driven, and the first-nozzle fuel is constantly injected from the first-nozzle radially outer fuel injection hole while the gas turbine is driven at a rated rotation speed.

2. The gas turbine according to claim 1, characterized in that the gas turbine further comprises:
a first-nozzle radially inner fuel supply pipe which is one pipe branched from a first-nozzle fuel system that supplies the first-nozzle fuel, and which communicates at a downstream end thereof with the first-nozzle radially inner fuel injection hole;
a first-nozzle radially outer fuel supply pipe which is another pipe branched from the first-nozzle fuel system and communicates at a downstream end thereof with the first-nozzle radially outer fuel injection hole;
a pressure adjustment valve which is provided upstream of a branch point in the first-nozzle fuel system and to which a pressure-adjustment-valve controller that controls a valve opening degree thereof is connected;
a first flow rate adjustment valve which is provided to the first-nozzle radially inner fuel supply pipe and to which a first-flow-rate-adjustment-valve controller that controls a valve opening degree thereof is connected; and
a second flow rate adjustment valve which is provided to the first-nozzle radially outer fuel supply pipe and to which a second-flow-rate-adjustment-valve controller that controls a valve opening degree thereof is connected, and
in the case where the first-nozzle fuel is made of the moderate calorie fuel, the pressure-adjustment-valve controller, the first-flow-rate-adjustment-valve controller, and the second-flow-rate-adjustment-valve controller control the valve opening degrees of the pressure adjustment valve, the first flow rate adjustment valve, and the second flow rate adjustment valve, respectively, so as to constantly inject the first-nozzle fuel from the first-nozzle radially inner fuel injection hole while the gas turbine is driven, and constantly inject the first-nozzle fuel further from the first-nozzle radially outer fuel injection hole while the gas turbine is driven at a rated rotation speed.

3. The gas turbine according to claim 1, characterized in that hole diameters of the first-nozzle radially inner fuel injection hole and the first-nozzle radially outer fuel injection hole are hole diameters suitable for a case where the first-nozzle fuel is made of the high calorie fuel.

4. A method of controlling a gas turbine being capable of load rejection and comprising a combustor for use with a high calorie fuel and a moderate calorie fuel,
the combustor including a first nozzle that injects a first-nozzle fuel into a flow of air inside the combustor, and a second nozzle that injects a second-nozzle fuel into the flow of air inside the combustor, the first-nozzle fuel being made of the high calorie fuel or the moderate calorie fuel, the second-nozzle fuel being made of the high calorie fuel or the moderate calorie fuel and combusted using, as a pilot, a flame obtained by combusting the fuel injected from the first nozzle,
the method characterized in that the method comprises:
providing the first nozzle with a first-nozzle radially inner fuel injection hole which is formed in a downstream tip portion of a body of the first nozzle and from which to inject the first-nozzle fuel and a first-nozzle radially outer fuel injection hole which is formed on a radially outer side of the first nozzle relative to the first-nozzle radially inner fuel injection hole and upstream of the first-nozzle radially inner fuel injection hole with respect to the flow of air inside the combustor and from which to inject the first-nozzle fuel; and
in a case where the first-nozzle fuel is made of the moderate calorie fuel, constantly injecting the first-nozzle fuel from the first-nozzle radially inner fuel injection hole while the gas turbine is driven, and constantly injecting the first-nozzle fuel from the first-nozzle radially outer fuel injection hole while the gas turbine is driven at a rated rotation speed.

5. The method of controlling a gas turbine according to claim 4, characterized in that the method further comprises:
providing the gas turbine with
a first-nozzle radially inner fuel supply pipe which is one pipe branched from a first-nozzle fuel system that supplies the first-nozzle fuel, and which communicates at a downstream end thereof with the first-nozzle radially inner fuel injection hole,
a first-nozzle radially outer fuel supply pipe which is another pipe branched from the first-nozzle fuel system and communicates at a downstream end thereof with the first-nozzle radially outer fuel injection hole,
a pressure adjustment valve which is provided upstream of a branch point in the first-nozzle fuel system and to which a pressure-adjustment-valve controller that controls a valve opening degree thereof is connected,
a first flow rate adjustment valve which is provided to the first-nozzle radially inner fuel supply pipe and to which a first-flow-rate-adjustment-valve controller that controls a valve opening degree thereof is connected, and
a second flow rate adjustment valve which is provided to the first-nozzle radially outer fuel supply pipe and to which a second-flow-rate-adjustment-valve controller that controls a valve opening degree thereof is connected; and
in the case where the first-nozzle fuel is made of the moderate calorie fuel, controlling the valve opening degrees of the pressure adjustment valve, the first flow rate adjustment valve, and the second flow rate adjustment valve so as to constantly inject the first-nozzle fuel from the first-nozzle radially inner fuel injection hole while the gas turbine is driven, and constantly inject the first-nozzle fuel further from the first-nozzle radially outer fuel injection hole while the gas turbine is driven at a rated rotation speed.

6. The method of controlling a gas turbine according to claim 4, characterized in that hole diameters of the first-nozzle radially inner fuel injection hole and the first-nozzle radially outer fuel injection hole are hole diameters suitable for a case where the first-nozzle fuel is made of the high calorie fuel.

7. The gas turbine according to claim 2, characterized in that hole diameters of the first-nozzle radially inner fuel injection hole and the first-nozzle radially outer fuel injection hole are hole diameters suitable for a case where the first-nozzle fuel is made of the high calorie fuel.

8. The method of controlling a gas turbine according to claim 5, characterized in that hole diameters of the first-nozzle radially inner fuel injection hole and the first-nozzle radially outer fuel injection hole are hole diameters suitable for a case where the first-nozzle fuel is made of the high calorie fuel.
